(19) United States
(12) Patent Application Publication
(10) Pub. No.: US 2015/0259209 A1
(43) Pub. Date: Sep. 17, 2015

(54) METHOD AND APPARATUS FOR CARRYING OUT A HYDROTHERMAL CARBONIZATION REACTION AND USE OF A SENSOR OR ANALYSIS DEVICE FOR THIS PURPOSE

(71) Applicant: AVA-CO2 Schweiz AG, Zug (CH)

(72) Inventor: Jan VYSKOCIL, Zug (CH)

(73) Assignee: AVA-CO2 SCHWEIZ AG, Zug (CH)

(21) Appl. No.: 14/644,369

(22) Filed: Mar. 11, 2015

(30) Foreign Application Priority Data
Mar. 12, 2014 (DE) 10 2014 103 346.9

(51) Int. Cl. C01B 31/02; G05B 15/02; B01J 19/24

(52) U.S. Cl. CPC C01B 31/02; B01J 19/24; G05B 15/02; B01J 2219/24; B01J 2219/00164

(57) ABSTRACT

It is the goal of a hydrothermal carbonization reaction to obtain the best possible yield of specific substances, for example the greatest possible carbon yield. However, biomass of very different types and grades is fed into the process, so that the reaction can take place very differently within each individual batch. Influencing the process is generally problematical, because the process proceeds in closed manner. For this reason, it is proposed to assign a sensor or an analysis device for the total organic carbon for the dissolved organic carbon, or for fractions of the total organic carbon. An adaptation of the process parameters can then be undertaken manually or by way of a process controller, as a function of the sensor's measurement results.

### CROSS REFERENCE TO RELATED APPLICATIONS

Applicant claims priority under 35 U.S.C. §119 of German Application No. 10 2014 103 346.9 field Mar. 12, 2014, the disclosure of which is incorporated by reference.

### BACKGROUND OF THE INVENTION

1. Field of the Invention

The present invention relates to a method for operation of a reactor using hydrothermal carbonization, the use of a sensor or of an analysis device for the total organic carbon, for the dissolved organic carbon, or for fractions of the total organic carbon, and an apparatus for carrying out a hydrothermal carbonization reaction.

2. The Prior Art

In a hydrothermal carbonization reaction, carbon and other byproducts are obtained from biomass, at elevated pressure and elevated temperature. Efficiency can be improved by using pressure and temperature correctly at certain points in time, and thereby following appropriately developed programs correctly, so that the biomass can be converted into carbonaceous substances that can be utilized, or into carbon itself, with very little energy being used.

In this connection, the efficiency is clearly increased by means of a suitable adaptation of the method to the biomass selected. Not only the parameters stated, but also further parameters such as the method and point in time of supplying steam, as well as the amount of steam supplied, play a prominent role in this regard, as does the composition of the supplied biomass. Fundamentally, therefore, an adaptation of the hydrothermal carbonization process to each biomass selected, would have to take place, in order to process the biomass selected in the most efficient way possible. In a rough outline, this is also easily possible by means of a selection of suitable settings, by hand, if, for example, liquid mixtures that contain carbon must be distinguished from garden waste. However, one type of garden waste also differs from another type of garden waste, so that here a more precise distinction will be required to further increase efficiency.

Since it is impossible to intervene in a hydrothermal carbonization process from the outside in practical manner, in view of the closed state of a reaction vessel, other possibilities are being sought, within the scope of the invention, for acting on the hydrothermal carbonization process in order to improve the efficiency of the process.

### SUMMARY OF THE INVENTION

Against this background, it is an object of the invention to obtain data from the ongoing carbonization process, on the basis of which data parameters of a hydrothermal carbonization process can be influenced from the outside, in order to improve the efficiency of the process.

This object is accomplished by a method for operation of a reactor within the scope of hydrothermal carbonization. Furthermore, this task is accomplished by means of the use of a sensor or of an analysis device for the total organic content, for the dissolved organic content, or for fractions of the total organic content. Finally, the problem is also solved by means of an apparatus for carrying out a hydrothermal carbonization reaction.

According to the invention, a bypass line is assigned to a reaction vessel in which the hydrothermal carbonization reaction takes place in a batch method, into which line the process water mixed with the biomass can run. This bypass line then has a sensor or also an analysis device assigned to it, with which values for the total organic carbon (TOC, Total Organic Carbon), for the dissolved organic carbon (DOC, Dissolved Organic Carbon), or for fractions of the total organic carbon can be determined. Using what is called a TOC or DOC sensor or a TOC or DOC analysis device, a list can be generated, stating what carbon compounds, including pure carbon, are present in the process water, and in what concentrations. From this, it is possible to derive the degree of progress of the hydrothermal carbonization reaction at a specific point in time, so that a well-founded estimate of the current status within the reactor is made possible.

Aside from purely obtaining information by way of the sensor or of the analysis device, these can also be set up in such a manner that a reporting signal is issued when a limit value of various monitored carbon compounds is exceeded, or fails to be exceeded, to which signal the operating personnel can react. Alternatively, a sensor or analysis device transmits such a signal directly to a process controller, which in turn either outputs the signal directly, passes it on to a control console, or itself intervenes in the process. In the latter case, means for influencing the hydrothermal carbonization reaction are assigned to the process controller, with which means it is possible to influence parameters such as the feed of biomass, the feed of steam, and pressure and temperature can also be influenced. For its orientation, the process controller will access database entries of a reference database and compare the measurement values of the sensor or of the sensors or of the analysis device or of the analysis devices with these database entries. In this connection, rulebooks for controlling the means for influencing the hydrothermal carbonization process are assigned to the database entries, so that the process controller can derive from them what measures must be taken. If no precise agreement of the measurement values with the predetermined database entries can be found, the process controller will select the closest value, in accordance with criteria that are also predetermined.

### BRIEF DESCRIPTION OF THE DRAWINGS

Other objects and features of the present invention will become apparent from the following detailed description considered in connection with the accompanying drawing. It is to be understood, however, that the drawing is designed as an illustration only and not as a definition of the limits of the invention.

FIG. 1 shows a diagram of a reactor according to the invention.

### DETAILED DESCRIPTION OF THE PREFERRED EMBODIMENT

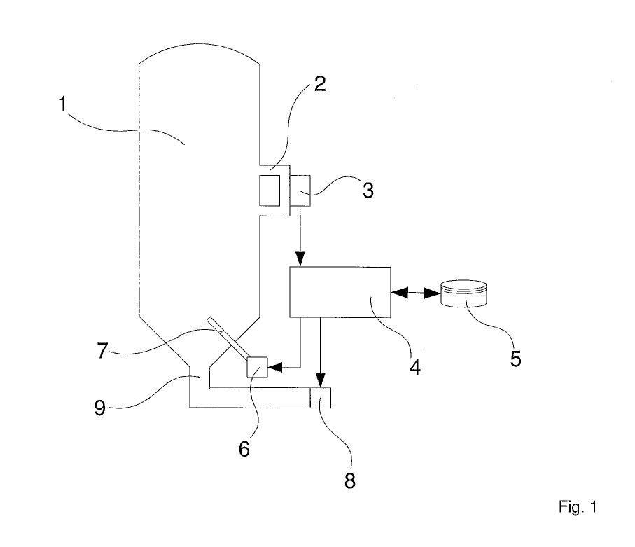

FIG. 1 shows a reaction vessel 1, to which a steam feed 7 and a slurry feed 9 are assigned. The hydrothermal carbonization reaction takes place in the interior of the reaction vessel 1 after steam and slurry have been fed in. Furthermore, a bypass line 2 is assigned to the reaction vessel 1, which line is filled with process water during the course of the hydrothermal carbonization reaction, which water flows through the bypass line 2. If necessary, a pump or another flow drive can also be assigned to the bypass line for this purpose, which pump or drive is provided for conveying the process water, mixed with slurry, through the bypass line. Furthermore, a sensor 3 for the total organic carbon (TOC sensor) is assigned to the bypass line 2, which sensor is able to identify and quantify pure carbon as well as multiple carbon compounds within the process water in the bypass line 2. In this manner, it can be determined how far advanced the carbonization reaction in the reaction vessel 1 already is at a specific point in time. From this, conclusions can be drawn as to whether or not an adaptation of the reaction conditions might be necessary. The sensor for the total organic carbon 3 passes its measurement data on to a process controller 4, which in turn is connected with a reference database 5. The reference database 5 comprises a plurality of database entries, which are selected on the basis of the measurement data delivered by the sensor 3 for the total organic carbon and made available to the process controller 4. Each database entry, independent of the measurement value that calls it up, has a rulebook according to which the hydrothermal carbonization reaction is to be influenced. Means for controlling the steam feed 6 as well as means for controlling the slurry feed 8 are provided to the process controller 4 for this purpose. If a measurement datum of the sensor 3 for the total organic carbon therefore reaches the process controller 4, the process controller 4 will call up a database entry from the reference database 5, which entry corresponds to the measurement datum, taking into consideration the time point of collection of the measurement data in relation to the start of the carbonization reaction or another reference time point, and will control the means for controlling the steam feed 6 as well as the means for controlling the slurry feed 8 in accordance with the rulebook stored in this data entry, and, if necessary, further controller components, not indicated in any detail here. In this way, the process can be adapted by means of the process controller 4, depending on the course of the hydrothermal carbonization reaction within the reaction vessel 1, in such a manner that it proceeds as efficiently as possible.

What has been described above is therefore a method and an apparatus for operation of a reactor within the scope of hydrothermal carbonization, as well as the use of a sensor or of an analysis device for the total organic carbon, for the dissolved organic carbon, or for fractions of the total organic carbon in a bypass line of the reaction vessel, with the goal of obtaining suitable information for influencing the ongoing hydrothermal carbonization process with regard to a possible increase in efficiency.

Accordingly, while only a few embodiments of the present invention have been shown and described, it is obvious that many changes and modifications may be made thereunto without departing from the spirit and scope of the invention.

### REFERENCE SYMBOL LIST

1 reaction vessel
2 bypass line
3 sensor for the dissolved organic carbon
4 process controller
5 reference database
6 means for controlling the steam feed
7 steam feed
8 means for controlling the slurry feed
9 slurry feed

What is claimed is:

1. A method for operation of a reactor for hydrothermal carbonization, comprising:
conducting a hydrothermal carbonization reaction in a reaction vessel having a bypass line; and
determining a concentration value for the total organic carbon or fractions of carbon in process water contained in the reaction vessel using a sensor or an analysis device.

2. The method according to claim 1, wherein the step of determining includes determining a concentration value for the carbon content using the sensor or analysis device.

3. The method according to claim 1, wherein the step of determining includes determining concentration values for one or more carbon compounds using the sensor or analysis device.

4. The method according to claim 1, wherein measurement values of the sensor or analysis device are compared with predetermined limit values and wherein a reporting signal is output to a process controller, depending on whether individual measurement values are exceeded or not reached.

5. The method according to claim 4, wherein the process controller outputs the reporting signal by way of an output device.

6. The method according to claim 4, wherein the process controller controls a device for influencing the hydrothermal carbonization reaction, and wherein the process controller compares an incoming reporting signal with database entries of a reference database, and implements a rulebook stored in memory in a corresponding database entry for controlling the device for influencing the hydrothermal carbonization reaction.

7. Use of a sensor or of an analysis device for determining total organic carbon, for dissolved organic carbon, or for fractions of the total organic carbon in a bypass line of a reaction vessel for a hydrothermal carbonization reaction, to obtain measurement data for a process controller for controlling a device for influencing the hydrothermal carbonization reaction.

8. An apparatus for carrying out a hydrothermal carbonization reaction, comprising:
a reaction vessel having a bypass line; and
a sensor or an analysis device adapted for determining the total organic carbon, for dissolved organic carbon, or for fractions of the total organic carbon, said sensor or analysis device being assigned to the bypass line.
